(19) United States
(12) Patent Application Publication
(10) Pub. No.: US 2008/0194734 A1
(43) Pub. Date: Aug. 14, 2008

(54) Modification of Thermolastic Vulcanizates with Particulate Fillers

(75) Inventor: Jean Maurice Lehmann, Paris (FR)

Correspondence Address: EXXONMOBIL CHEMICAL COMPANY, 5200 BAYWAY DRIVE, P.O. BOX 2149, BAYTOWN, TX, 77522-2149, US

(73) Assignee: ADVANCED ELASTOMER SYSTEM, L.P., Akron, OH (US)

(21) Appl. No.: 11/659,265

(22) PCT Filed: Sep. 21, 2004
(86) PCT No.: PCT/US04/30854

§ 371 Date: Jan. 3, 2008

(51) Int. Cl. C08K 3/40; C08J 3/22

(52) U.S. Cl. 523/351; 524/494

(57) ABSTRACT

Microspherical fillers are used to increase the scratch resistance of thermoplastic vulcanizates in extruded profiles while providing aesthetically attractive surface effects. The thermoplastic vulcanizates comprise a thermoplastic phase and a rubber that is at least partially cross-linked by dynamic vulcanization. The fillers can be added by melt blending with the pre-formed thermoplastic vulcanizate. An attractive, granite-like appearance can be achieved with enhanced scratch resistance that is particularly suitable as automotive interior or exterior trim parts.

### CROSS REFERENCE TO RELATED PATENT APPLICATIONS

This application claims priority to PCT/US2004/030854, filed on Sep. 21, 2004, the disclosures of which are incorporated by reference.

### FIELD OF INVENTION

The invention relates to extruded profiles for use in consumer articles where a flexible-feel surface having dimensional stability and good scratch resistance is desired. Additionally, aesthetic appearance of a grainy surface is often desired, especially that approaching the appearance of granite stone surfaces. Such profiles find ready application in the automotive industry, particularly in interior and exterior trim components.

### BACKGROUND OF INVENTION

The vehicle industry, particularly the automotive industry, is an important segment of the international economy and its products are in use worldwide. One class of parts, or components, is that directed to interior or exterior decorative panels, pads and other overlay surfaces. Such may need energy-absorbent padding qualities for passenger comfort and safety, and will need both dimensional stability for occasional hot atmospheric conditions and scratch resistance characteristics for retention of aesthetic appearance. Plasticized polyvinylchloride has been the plastic of choice for some such applications, see for example U.S. Pat. No. 5,247,012. It has been coextruded with metal and has been able to provide an aesthetically attractive granite like surface aspect as prepared. However, such composites may tend to give off hazardous chemical vapors and have been discouraged for use in many applications for those reasons. Additionally, such composites are not readily recyclable and fail to assist the automotive manufacturers to meet recyclable content standards that are continuing to gain importance in social regulation.

Further, U.S. Pat. No. 4,556,603 teaches the addition of hollow, microsphere particulate materials to thermoplastic elastomer compositions normally being solid, block copolymers of butadiene and styrene for the purposes of preparing a lightweight, sheet-type structure of improved mechanical strength suitable for use as sound or heat insulating material for automotive, aircraft and construction uses.

### SUMMARY OF INVENTION

The scratch-resistant profiles according to the invention can be prepared by melt blending microspherical particulate fillers with a preformed thermoplastic vulcanizate containing thermoplastic and cross-linked hydrocarbon elastomer. More particularly the profiles are prepared from a thermoplastic elastomer composition comprising a) 65 to 90 wt. % of said composition consisting of a thermoplastic vulcanizate comprising a thermoplastic phase, and at least one, at least partially cross-linked, hydrocarbon elastomer, wherein said thermoplastic vulcanizate exhibits a durometer greater than 50 Shore A; and, b) 10 to 35 wt. %, based upon total composition, of microspheres having a average particle size of 75-150 microns. The melt blending for preparing the invention compositions comprises melt processing the described thermoplastic vulcanizate and microspheres in an extruder wherein said melt processing is conducted such that the melt temperature during extrusion and upon exit from the extruder die does not exceed 200° C. The invention compositions are suitable as extruded profiles, having a granite-like surface aspect, useful in or as exterior or interior vehicle trim components or articles.

### DETAILED DESCRIPTION OF THE INVENTION

The microspherical particulate fillers, microspheres, used to modify thermoplastic vulcanizates in this invention are best exemplified by solid glass microspheres having a average particle size of 75-150 microns. In a preferred embodiment the particle size distribution will be such that not greater than about 20 wt. % of said particles have a particle size less than 75 microns, not more than about 20 wt. % of said particles have a particle size greater than 150 microns, and not greater than 2 wt. % have a particle size greater than 180 microns. Other materials that are stable, that is capable of withstanding temperatures in access of 200° C. without melting or significant heat deformation, and available in the particle size characteristics described will be suitable as well. Ceramic microspheres, polyimide microspheres, ultrahigh molecular weight high density polyethylene (UHDPE) and the like, are examples. The microspheres are preferably solid microspheres, but hollow microspheres having sufficiently thick walls to provide abrasion resistance without significant breakage will be suitable as well. Those having coupling agent treatments, such as those well-known in the glass fiber field, can also be used for increased toughness of the overall composites in accordance with the invention.

Solid glass microspheres, or beads, suitable in accordance with the invention are available from Sovitec Cataphote in France, 3M Specialty Materials and Potters Industries, Inc., in the U.S.A. Whether as-acquired, or subsequently treated, the glass microspheres can be functionalized for improved binding to thermoplastic resins, for example, those that have been amino-treated for coupling with carboxylated moieties on polymeric additives, see below.

The microspherical particulate fillers are desirably present in amounts from about 5 to about 20 wt. % of the total weight of microsphere plus thermoplastic elastomer, more desirably in amounts from about 8 to about 18 wt. %, still more desirably from about 10 to about 15 wt. %.

Thermoplastic vulcanizates (TPVs) are thermoplastic elastomers that are characterized by having crosslinked hydrocarbon elastomer particles dispersed within a plastic matrix. The crosslinked elastomer phase promotes elasticity but due to the segregated nature of the particles and their largely homogeneous dispersion, it does not interfere with plasticity. As such, TPVs exhibit the processing properties of the plastic and the elasticity of the rubber. Further, the TPVs in final form either as compounding scrap material or when separated from other materials to which attached, may be melted and molded again without significant loss of mechanical properties making them exceptionally suitable for recycling.

Such TPVs are conventionally produced by dynamic vulcanization. Dynamic vulcanization is a process whereby at least one elastomer, or rubber, component is crosslinked or vulcanized under intensive shear and mixing conditions within a blend of at least one non-vulcanizing thermoplastic polymer component while at or above the melting point of the thermoplastic. See, for instance, the descriptions of U.S. Pat. Nos. 4,130,535, 4,311,628, 4,594,390, and 4,607,104. Subsequent to dynamic vulcanization (curing) of the rubber phase of the thermoplastic vulcanizate, desirably less than 5 weight percent of the rubber is extractable from the specimen of the thermoplastic vulcanizate in boiling xylene. Techniques for determining extractable rubber as set forth in U.S. Pat. No. 4,311,628, are herein incorporated by reference.

The thermoplastic resin used in the invention is a solid plastic material. Preferably, the resin is a crystalline or a semi-crystalline polymer resin, and more preferably is a resin that has a crystallinity of at least 10 percent as measured by differential scanning calorimetry. Polymers with a high glass transition temperature, e.g., non-crystalline engineering plastics, are also acceptable as the thermoplastic resin. The melt temperature of these resins should generally be lower than the decomposition temperature of the rubber. Reference to a thermoplastic resin includes a mixture of two or more different thermoplastic resins.

The thermoplastic resins preferably have a weight average molecular weight from about 50,000 to about 600,000, and a number average molecular weight from about 50,000 to about 200,000. More preferably, these resins have a weight average molecular weight from about 150,000 to about 500,000, and a number average molecular weight from about 65,000 to about 150,000.

The thermoplastic resins generally have a melt temperature (Tm) that is from about 40 to about 175° C. preferably from about 50 to about 170° C. and even more preferably from about 90 to about 170° C. In a most preferred embodiment, the Tm of the thermoplastic phase is at or above 140° C. The glass transition temperature (Tg) of these resins is from about −25 to about 10° C. preferably from about −5 to about 5° C.

The thermoplastic resins generally have a melt flow rate that is less than about 100 dg/min, preferably less than about 10 dg/min, and still more preferably less than about 0.8 dg/min. The melt flow rate is generally to be above about 0.3 dg/min. Melt flow rate is a measure of how easily a polymer flows under standard pressure, and is measured by using ASTM D-1238 at 230° C. and 2.16 kg load.

Exemplary thermoplastic resins include crystallizable polyolefins The preferred thermoplastic resins are crystallizable polyolefins that are formed by polymerizing alpha-olefins such as ethylene, propylene, 1-butene, 1-hexene, 1-octene, 2-methyl-1-propene, 3-methyl-1-pentene, 4-methyl-1-pentene, 5-methyl-1-hexene, and mixtures thereof. For example, known polyethylene homo- and copolymers having ethylene crystallinity are suitable. Isotactic or syndiotactic polypropylene and crystallizable copolymers of propylene and ethylene or other C4-C10 alpha-olefins, or diolefins, having isotactic or syndiotactic propylene crystallinity are typically preferred. Copolymers of ethylene and propylene or ethylene or propylene with another alpha-olefin such as 1-butene, 1-hexene, 1-octene, 2-methyl-1-propene, 3-methyl-1-pentene, 4-methyl-1-pentene, 5-methyl-1-hexene or mixtures thereof are also suitable. These will include reactor polypropylene copolymers and impact polypropylene copolymers, whether block, random or of mixed polymer synthesis. These homopolymers and copolymers may be synthesized by using any polymerization technique known in the art such as, but not limited to, the “Phillips catalyzed reactions,” conventional Ziegler-Natta type polymerizations, and organometallic single-site olefin polymerization catalysis exemplified by, but not limited to, metallocene-alumoxane and metallocene-ionic activator catalysis.

The polypropylene is typically from about 15 to about 85 weight percent, more desirably from about 25 to about 85 weight percent of the thermoplastic vulcanizate. Typically the rubber is from about 15 to about 85, more desirably about 15 to about 75 weight percent of the thermoplastic vulcanizate.

Any rubber capable of vulcanization will be suitable in accordance with the invention, but the largely hydrocarbon elastomers containing unsaturation are preferred. Such will include polyolefin rubbers, natural rubber, nitrile rubber, polybutadiene rubber, polyisoprene rubber, styrene butadiene rubber, and butadiene-acrylonitrile rubber, etc. See, e.g., U.S. Pat. No. 4,104,210. Amine-functionalized, carboxyl-functionalized or epoxy-functionalized synthetic rubbers may be used, and examples of these include maleated EPDM, and epoxy-functionalized natural rubbers. These materials are commercially available.

A particularly preferred hydrocarbon elastomer is a polyolefin such as EP rubber or, especially, EPDM rubber which, because of the random nature of its repeat structure or side groups, tends not to crystallize. Such polyolefin rubbers are generally copolymers derived from the polymerization of at least two different monoolefin monomers having from 2 to 10 carbon atoms, preferably 2 to 4 carbon atoms, and, for EPDM terpolymers, at least one polyunsaturated olefin having from 5 to 20 carbon atoms. Said monoolefins desirably have contain 1-12 carbon atoms and are preferably ethylene and propylene, but ethylene with 1-butene, 1-hexene, or 1-octene, are also readily suitable. Desirably the repeat units from at least two monoolefins are present in the polymer in weight ratios of 25:75 to 75:25 (ethylene:propylene) and constitute from about 90 to 100 weight percent of the polymer. The polyunsaturated olefin can be a straight chained, branched, cyclic, bridged ring, bicyclic, fused ring bicyclic compound, etc., and preferably is a nonconjugated diene. Desirably repeat units from the polyunsaturated olefin is from about 0.4 to about 10 weight percent of the rubber. Preferred nonconjugated dienes have 5 to 20 carbon atoms, and are preferably one or more selected from ethylidene norbornene, vinyl norbornene, 1,4-hexadiene, dicyclopentadiene, and the like.

Another particularly suitable hydrocarbon elastomer, or polyolefin rubber, can be a butyl rubber, halobutyl rubber, or a halogenated (e.g. brominated) copolymer of p-alkylstyrene and an isomonoolefin of 4 to 7 carbon atoms. “Butyl rubber” is defined a polymer predominantly comprised of repeat units from isobutylene but including a few repeat units of a monomer which provides sites for crosslinking. The monomers which provide sites for crosslinking can be a polyunsaturated monomer such as a conjugated diolefin or divinyl benzene. Desirably from about 90 to about 99.5 weight percent of the butyl rubber are repeat units derived from the polymerization of isobutylene, and from about 0.5 to about 10 weight percent of the repeat units are from at least one polyunsaturated monomer having from 4 to 12 carbon atoms. Preferably the polyunsaturated monomer is isoprene, a para-alkylsyrene or divinylbenzene. The polymer may be halogenated to further enhance reactivity in crosslinking. Preferably the halogen is present in amounts from about 0.1 to about 10 weight percent, more preferably about 0.5 to about 3.0 weight percent based upon the weight of the halogenated polymer; preferably the halogen is chlorine or bromine. The brominated copolymer of p-alkylstyrene, having from about 9 to 12 carbon atoms, and an isomonoolefin, having from 4 to 7 carbon atoms, desirably has from about 88 to about 99 weight percent isomonoolefin, more desirably from about 92 to about 98 weight percent, and from about 1 to about 12 weight percent p-alkylstyrene, more desirably from about 2 to about 8 weight percent based upon the weight of the copolymer before halogenation. Desirably the alkylstyrene is p-methylstyrene and the isomonoolefin is isobutylene. Desirably the percent bromine is from about 2 to about 8, more desirably from about 3 to about 8, and preferably from about 5 to about 7.5 weight percent based on the weight of the halogenated copolymer. The halogenated copolymer is a complementary amount, i.e., from about 92 to about 98, more desirably from about 92 to about 97, and preferably from about 92.5 to about 95 weight percent. These polymers are commercially available from ExxonMobil Chemical Co.

Other rubber such as natural rubber or homo or copolymers from at least one conjugated diene can be used in the dynamic vulcanizate. These rubbers are higher in unsaturation than EPDM rubber and butyl rubber. The natural rubber and said homo or copolymers of a diene can optionally be partially hydrogenated to increase thermal and oxidative stability. The synthetic rubber can be nonpolar or polar depending on the comonomers. Desirably the homo or copolymers of a diene have at least 50 weight percent repeat units from at least one conjugated diene monomer having from 4 to 8 carbon atoms. Comonomers may be used and include vinyl aromatic monomer(s) having from 8 to 12 carbon atoms and acrylonitrile or alkyl-substituted acrylonitrile monomer(s) having from 3 to 8 carbon atoms. Other comonomers desirably used include repeat units from monomers having unsaturated carboxylic acids, unsaturated dicarboxylic acids, unsaturated anhydrides of dicarboxylic acids, and include divinylbenzene, alkylacrylates and other monomers having from 3 to 20 carbon atoms. Examples of synthetic rubbers include synthetic polyisoprene, polybutadiene rubber, styrene-butadiene rubber, butadiene-acrylonitrile rubber, etc. Amine-functionalized, carboxy-functionalized or epoxy-functionalized synthetic rubbers may be used, and examples of these include maleated EPDM, and epoxy-functionalized natural rubbers. These materials are commercially available.

The thermoplastic vulcanizates of this disclosure are generally prepared by melt-processing the olefin(s) thermoplastic (e.g. polypropylene), the hydrocarbon elastomer (rubber), and other ingredients (plasticizer, lubricant, stabilizer, etc.) in a mixer heated to above the melting temperature of the semi-crystalline polypropylene. The optional fillers, plasticizers, additives etc., can be added at this stage or later. After sufficient molten-state mixing to form a well mixed blend, vulcanizing agents (also known as curatives or crosslinkers) are generally added. In some embodiments it is preferred to add the vulcanizing agent in solution with a liquid, for example rubber processing oil, or in a masterbatch which is compatible with the other components. It is convenient to follow the progress of vulcanization by monitoring mixing torque or mixing energy requirements during mixing. The mixing torque or mixing energy curve generally goes through a maximum after which mixing can be continued somewhat longer to improve the fabricability of the blend. If desired, one can add some of the ingredients after the dynamic vulcanization is complete. After discharge from the mixer, the blend containing vulcanized rubber and the thermoplastic can be milled, chopped, extruded, pelletized. injection-molded, or processed by any other desirable technique. It is usually desirable to allow the fillers and a portion of any plasticizer to distribute themselves in the rubber or semi-crystalline polypropylene phase before the rubber phase or phases are crosslinked. Crosslinking (vulcanization) of the rubber can occur in a few minutes or less depending on the mix temperature, shear rate, and activators present for the curative. Suitable curing temperatures include from about 120° C. or 150° C. for a semi-crystalline polypropylene phase to about 250° C., more preferred temperatures are from about 150° C. or 170° C. to about 225° C. or 250° C. The mixing equipment can include Banbury® mixers, Brabender® mixers, and certain mixing extruders. Particularly, twin-screw extruders. See, for example U.S. Pat. Nos. 4,594,390 and 6,147,160.

The thermoplastic vulcanizate can include a variety of additives. The additives include particulate fillers such as carbon black, silica, titanium dioxide, colored pigments, clay, zinc oxide, stearic acid, stabilizers, anti-degradants, flame retardants, processing aids, adhesives, tackifiers, plasticizers, wax, discontinuous fibers (such as wood cellulose fibers) and extender oils. When extender oil is used it can be present in amounts from about 5 to about 300 parts by weight per 100 parts by weight of the blend of thermoplastic and cross-linked rubber. The amount of extender oil (e.g., hydrocarbon oils and ester plasticizers) may also be expressed as from about 30 to 250 parts, and more desirably from about 70 to 200 parts by weight per 100 parts by weight of said rubber. When non-black fillers are used, it is desirable to include a coupling agent to compatibilize the interface between the non-black fillers and polymers. Desirable amounts of carbon black, when present, are from about 5 to about 250 parts by weight per 100 parts by weight of rubber. The TPV compositions are typically available as thermoplastic pellets. The polyolefinic, fully-crosslinked rubber-containing TPV SANTOPRENE® products of Advanced Elastomer Systems, L.P. are particularly suitable.

In addition, polymeric additives can be used to modify the overall properties of the invention TPV compositions. Known polymeric additives include thermoplastics such as un-crosslinked ethylene-propylene rubber, very low density polyethylene copolymers, styrene block copolymers, particularly, styrene-ethylene-butene-styrene thermoplastics, and semi-crystalline propylene homopolymers or random copolymers having from about 1-20 wt. % of ethylene or α-olefins containing 4-8 carbon atoms. Such modifiers may also be functionalized with polar moieties, such as carboxy-acids/anhydrides, amino-, epoxy- and similar moieties. Such may be added to the TPV during its production or may be subsequently added by melt processing. Preferred additives for increased bonding of the TPV to glass beads, particularly, sized, or treated, glass beads are functionalized polyolefin thermoplastics such as semi-crystalline polypropylene homo- or copolymers, ethylene copolymers, or hydrogenated styrene block copolymers that have been grafted with maleic anhydride. Commercial polymers useful for such include Exxelor® PO 1015 (polypropylene functionalized with 0.25 to 0.5 wt. % maleic anhydride, ExxonMobil Chemical Company) and Exxelor® VA 1840 (ethylene copolymer functionalized with 0.25 to 0.5 wt. % maleic anhydride, ExxonMobil Chemical Company), and KRATON® FG1901X (styrene-ethylene-butene-styrene copolymer functionalized with 1.7 to 2.0 wt. % maleic anhydride, Kraton Polymers). Such polymeric additives may present in an amount up to 20 wt. % of the total polymeric content, and will typically be used in a range of 10-20 wt. % when present.

The reinforced thermoplastic elastomer compositions in accordance with the invention can be prepared by selecting the base TPV product in accordance with the above description and melt mixing with the described microspheres. The resulting product can be finished as sheets, bales or pellets, in accordance with standard methods for finishing thermoplastic products. Thus the compositions of the invention can be prepared in the following manner, the TPV product is heated to above its melting temperature, typically, 170 to 230° C., and mixed with the microspheres while in a molten state, typically in an internal mixer such as a Banbury, Buss extruder, or single or twin screw extruder. In an alternative method, the microspheres can be dry blended with TPV pellets, optionally with other dry additives, with subsequent melt mixing or processing of the blend. A masterbatch addition of microspheres, in thermoplastic or TPV material, to molten TPV, such as that of U.S. Pat. No. 4,556,603, can be utilized as well.

Thermoplastic vulcanizate compositions of the invention are useful for making a variety of articles such as weatherseals for vehicles or construction, exterior or interior vehicle trim articles, particularly automotive trim parts, and other extruded profiles.

### EXAMPLES

Initial screening was conducted to determine the effect of extrusion temperature on the surface texture of unmodified polyolefin thermoplastic vulcanizates. The recommended temperature from the manufacturer's typical thermoplastic vuclanizate product specifications for processing is from 177 to 232° C. It was empirically determined that a rough surface, as opposed to a smooth surface, by visual inspection, was achieved by adjusting conditions to achieve a melt temperature of not more than about 200° C. The rough surface however was comprised of surface cracks or breaks with ridge lines of varying height above the surface. This rough sharkskin appearance achieved is not suitable for interior automobile trim components being too absorbent of extraneous liquids, oils, and other soft materials. Accordingly a surface with more integrity and regular patterning without breaks was still to be achieved.

All tests, other than the initial screening tests, were conducted with extruded strips prepared using a Mapre, single screw extruder with bore diameter from 30-38 mm, an L/D of 25-30, a grooved barrel, and a flat exit die measuring 22×1 mm. Though several thermoplastic vulcanizate products were tested, a representative sampling illustrative of the invention is SANTOPRENE® 121-87W175, an extrusion grade polyolefin TPV having a Shore A hardness of 87 (ASTM D 2240), a density of 0.97 g/cm³, and a black color from included carbon black (available from Advanced Elastomer Systems L.P. in the U.S. and ExxonMobil Chemical Europe in Europe). All samples below were conducted with this product.

The test strips were prepared by extrusion through the Mapre using an extruder temperature profile (in ° C.) of:

| Inlet | Second | Third | Fourth | Die Outlet |
|---|---|---|---|---|
| 150-160 | 155-170 | 160-180 | 160-190 | 158-190 |

Within these ranges the temperatures were generally selected to be increasing from inlet to the fourth stage, the die outlet being at or below that of the fourth stage. The melt temperature of the microsphere reinforced TPV extrudate was varied from 171 to 204° C.

Solid microspheres were added at the inlet with TPV pellets, though introduction separately of the solid microspheres into the TPV melt after the inlet stage could be utilized. The following microsphere/particle products were tested.

TABLE 1

| | | | aps* | particle size | |
|---|---|---|---|---|---|
| supplier | product | material | (microns, μ) | distribution | wt. % |
| Sovitec | 050-40 | glass | 50 | >45μ 90% | 15 |
| Cataphote | | beads | | >63μ 10% | |
| (comparative) | | | | >90μ 1% | |
| Sovitec | 75-150 | glass | 75-150 | >75μ 90% | 15, 10 |
| Cataphote | | beads | | >150μ 10% | |
| | | | | >180μ 1% | |
| Sovitec | AD | glass | 150-250 | >150μ 10% | 10 |
| Cataphote | | beads | | >200 15% | |
| | | | | >250 1% | |

*note: aps = average particle size

Successful runs were achieved only with the Sovitec™ 75-150 and Sovitec™ AD. Melt temperatures were maintained less than 200° C., specifically at 184, 191 and 191° C. The other samples were run at comparable melt temperatures of 183-186° C. The unsuccessful samples exhibited varying degrees of roughness with the comparative Sovitec 050-40 pellets having such roughness but insignificant surface aspect improvement.

While in accordance with the patent statutes the best mode and preferred embodiment has been set forth, the scope of the invention is not limited thereto, but rather by the scope of the attached claims.

What is claimed is:

1. A reinforced thermoplastic elastomer composition comprising:
a) from 65 to 90 weight percent, based on the weight of the reinforced thermoplastic elastomer composition, of a thermoplastic vulcanizate comprising:
an olefin thermoplastic phase, and
at least one, at least partially cross-linked, hydrocarbon elastomer, wherein the thermoplastic vulcanizate exhibits a durometer greater than 50 Shore A; and
b) from 10 to 35 weight percent of microspheres having an average particle size of from 75 to 150 microns.

2. The reinforced thermoplastic elastomer composition of claim 1, wherein the olefin thermoplastic phase comprises:
one or more of isotactic polypropylene, syndiotactic polypropylene, or random copolymer of propylene, and
at least one of ethylene and C₄-C₁₀ α-olefins, or an impact polypropylene copolymer,
wherein the thermoplastic phase exhibits a melting point by DSC at or above 120° C.

3. The reinforced thermoplastic elastomer composition of claim 1, wherein the hydrocarbon elastomer is an ethylene copolymer rubber or an EPDM rubber.

4. The reinforced thermoplastic elastomer composition of claim 1, wherein the thermoplastic vulcanizate has been vulcanized such that not more than 5 weight percent, based on the weight of hydrocarbon elastomer, of the cross-linked hydrocarbon elastomer is extractable in boiling xylene.

5. The reinforced thermoplastic elastomer composition of claim 1, wherein the microspheres are solid glass beads.

6. A process for preparing a thermoplastic composition comprising the steps of:
(a) melt processing a thermoplastic vulcanizate and microspheres in a single or twin-screw extruder at a melt temperature not more than 200° C., wherein the thermoplastic composition comprises:
(i) from 65 to 90 weight percent, based on the weight of the reinforced thermoplastic elastomer composition, of a thermoplastic vulcanizate comprising:
an olefin thermoplastic phase, and
at least one, at least partially cross-linked, hydrocarbon elastomer, wherein the thermoplastic vulcanizate exhibits a dutometer greater than 50 Shore A; and
(ii) from 10 to 35 weight percent of microspheres having an average particle size of from 75 to 150 microns.

7. The process for preparing a thermoplastic composition of claim 6, wherein the microspheres are added to the thermoplastic vulcanizate during melt processing of the thermoplastic vulcanizate.

8. The process for preparing a thermoplastic composition of claim 6, wherein the microspheres are masterbatched with thermoplastic or thermoplastic vulcanizate.

9. The process for preparing a thermoplastic composition of claim 6, wherein the microspheres are dry-blended with pellets of the thermoplastic vulcanizate for subsequent melt-processing of the blend.

10. The process for preparing a thermoplastic composition of claim 6, wherein the thermoplastic vulcanizate comprises a thermoplastic phase comprising polypropylene and an at least partially cross-linked ethylene copolymer rubber or an EPDM rubber.

11. The process for preparing a thermoplastic composition of claim 10, wherein the thermoplastic phase further comprises a functionalized polyolefin thermoplastic and the microspheres have been treated for bonding to the functionalized polyolefin thermoplastic.

12. The process for preparing a thermoplastic composition of claim 11, wherein the microspheres are solid glass beads.

13. The process for preparing a thermoplastic composition of claim 6, wherein the olefin thermoplastic phase comprises:
one or more of isotactic polypropylene, syndiotactic polypropylene, or random copolymer of propylene, and
at least one of ethylene and C₄-C₁₀ α-olefins, or an impact polypropylene copolymer,
wherein the thermoplastic phase exhibits a melting point by DSC at or above 120° C.

14. The process for preparing a thermoplastic composition of claim 6, wherein the hydrocarbon elastomer is an ethylene copolymer rubber or an EPDM rubber.

15. The process for preparing a thermoplastic composition of claim 6, wherein the thermoplastic vulcanizate has been vulcanized such that not more than 5 weight percent, based on the weight of hydrocarbon elastomer, of the cross-linked hydrocarbon elastomer is extractable in boiling xylene.

16. The process for preparing a thermoplastic composition of claim 6, wherein the microspheres are solid glass beads.

17. A vehicular exterior or interior trim article comprising:
a thermoplastic elastomer extrudate composition comprising:
a) 65 to 90 weight percent, based on the weight of thermoplastic elastomer extrudate composition, of a thermoplastic vulcanizate comprising:
(i) an olefin thermoplastic phase, and
(ii) at least one, at least partially cross-linked, hydrocarbon elastomer,
wherein the thermoplastic vulcanizate exhibits a durometer greater than 50 Shore A, and
b) 10 to 35 weight percent of microspheres having an average particle size of from 75 to 150 microns.

18. The vehicular exterior or interior trim article of claim 17, wherein the olefin thermoplastic phase comprises:
one or more of isotactic polypropylene, syndiotactic polypropylene, or random copolymer of propylene, and
at least one of ethylene and C₄-C₁₀ α-olefins, or an impact polypropylene copolymer,
wherein the thermoplastic phase exhibits a melting point by DSC at or above 120° C.

19. The vehicular exterior or interior trim article of claim 17, wherein the hydrocarbon elastomer is an ethylene copolymer rubber or an EPDM rubber.

20. The vehicular exterior or interior trim article of claim 17, wherein the thermoplastic vulcanizate has been vulcanized such that not more than 5 weight percent, based on the weight of hydrocarbon elastomer, of the cross-linked hydrocarbon elastomer is extractable in boiling xylene.

21. The vehicular exterior or interior trim article of claim 17, wherein the microspheres are solid glass beads.
